(19) United States
(12) Patent Application Publication
(10) Pub. No.: US 2007/0074071 A1
(43) Pub. Date: Mar. 29, 2007

(54) Processor thermal management

(76) Inventors: Michael Rothman, Puyallup, WA (US); Vincent J. Zimmer, Federal Way, WA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/236,404

(22) Filed: Sep. 27, 2005

(51) Int. Cl. G06F 11/00

(52) U.S. Cl. 714/10

(57) ABSTRACT

Apparatus and systems, as well as methods and articles, may operate to sense a thermal trip condition indicated by a first processor executing a process, and to transfer the process from the first processor to a second processor in response to sensing the thermal trip condition.

### RELATED APPLICATIONS

This disclosure is related to U.S. patent application Ser. No. ______, titled “Method for Driver Safety”, filed on ______, attorney docket No. P22478, and assigned to the assignee of the embodiments disclosed herein, Intel Corporation.

### TECHNICAL FIELD

Various embodiments described herein relate to thermal management generally, including apparatus, systems, and methods used to manage thermal conditions in a data processing environment.

### BACKGROUND INFORMATION

In some processors, a thermal monitor exists that attempts to control the processor temperature by thermal throttling, or modulating (e.g., starting and stopping) the internal processor core clocks. For example, as the processor temperature approaches a selected limit, the clocks may be modulated so as to maintain a duty cycle of about 30% to 50%. Thus, processor performance may decrease significantly as the effective processing power is lowered to maintain a desired thermal loading.

### BRIEF DESCRIPTION OF THE DRAWINGS

FIG. 1 is a block diagram of apparatus and systems according to various embodiments of the invention.

FIG. 2 is a flow diagram illustrating several methods according to various embodiments of the invention.

FIG. 3 is a block diagram of an article according to various embodiments.

### DETAILED DESCRIPTION

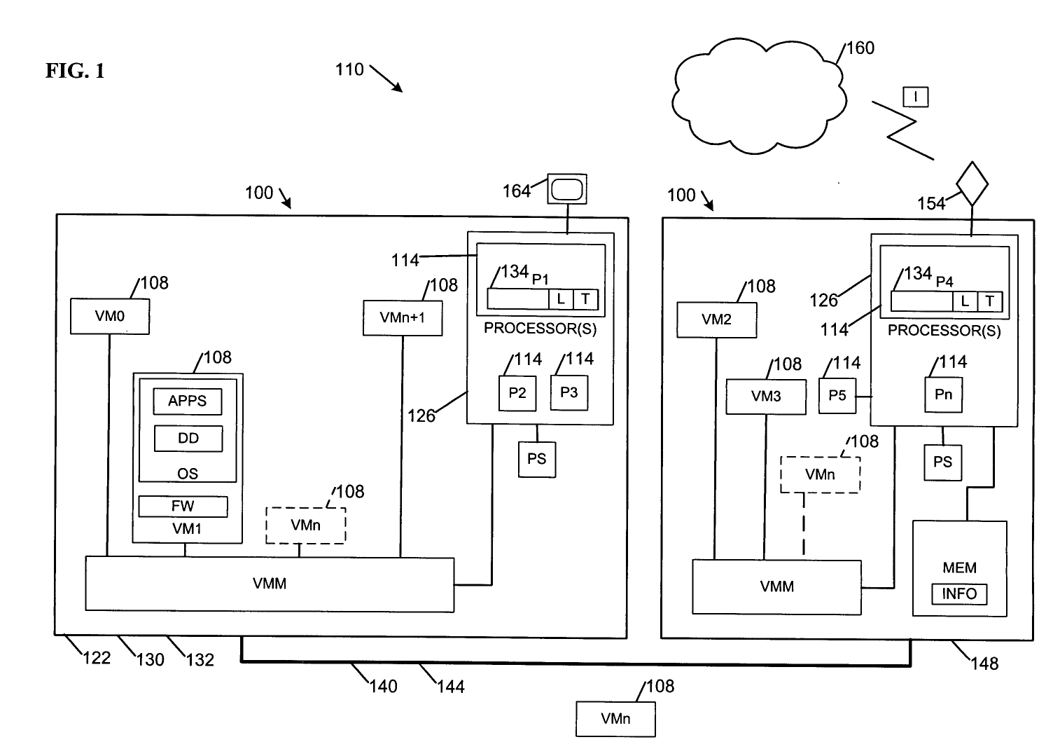

FIG. 1 is a block diagram of apparatus 100 and systems 110 according to various embodiments of the invention. The apparatus 100 may include several processors 114, including a first processor P1 to indicate a thermal trip condition associated with the first processor, and a second processor P2 to receive one or more processes 108 from the first processor P1, perhaps in response to the indication of the thermal trip condition. It should be noted that while the discussion below utilizes processors P1 and P2 as examples, this is only as a matter of convenience. Any of the other processors 114 (e.g., P3, P4, . . . , P5, Pn) can be substituted for the specific designations of P1 and P2 which follow.

When a certain quantity of operations are executed by the processor p1 within a given time period, the core temperature of the processor P1 may increase. Thus, despite a variety of cooling mechanisms, thermal fluctuations can occur. If the processor temperature exceeds a pre-determined value (e.g., 90 C.), thermal throttling may be invoked to reduce heat dissipation, resulting in reduced overall processing power.

In some embodiments, after the thermal trip condition is indicated (e.g., via the status of a flag or status bit T in the first processor p1), and the processes have been transported from the first processor p1 so as to be received by the second processor P2, the second processor P2 may execute the processes. In this manner, a mechanism is provided by which a platform 122, such as a motherboard 130 or computer 132, can balance operational loading to operate more efficiently in the face of thermal considerations.

Thus, some embodiments may permit re-assignment of processes 108 from a first processor p1 that has indicated a thermal trip condition (e.g., wherein some temperature associated with the processor p1 has exceeded a desired value), possibly inducing thermal throttling, to a second processor P2 that is less encumbered. The net result can be to increase the overall efficiency of platform 122 operation. In this manner, it is even possible that thermal throttling may be avoided entirely, at least during the execution of some applications.

Integrated circuit packages 126 may include one or more processor cores (e.g., package 126 may include processors p1, P2, P3 or processors P4, P5, . . . , Pn), and there may be one or more thermal sensors included in an integrated circuit package 126. Thus, in some embodiments, each processor (e.g., p1, P2, P3) in a single integrated circuit package 126 may have its own thermal sensor. Each processor p1, P2, P3 in the package 126 may be substantially thermally isolated from the other processors in the package 126, such that a temperature fluctuation in one core may result in less than a 25% or 10% mirroring fluctuation in another core (e.g., for 25% mirroring, if the core temperature of p1 rises from 70 C. to 90 C., then the core temperature of P2 may only change from 70 C. to 75 C. as a result; for 10% mirroring, the rise in the temperature of processor P2 should be less than 2 C.).

It should be noted that process transport may be accomplished by containerizing or encapsulating the processes 108 prior to transfer. That is, system designers may choose to transport processes by implementing process isolation mechanisms. Specifically, basic operating system (OS)—environments called Driver Shim Operating Systems (DSOS's) may include a thin layer of code that models the specific device driver environment of a given OS. In some embodiments, the DSOS may provide the application interface and environment of the Microsoft® Windows® Input/Output Manager. The DSOS can be carried by the platform code and constructed to contain only one of the shrink-wrapped device drivers for the system.

In some embodiments, the DSOS may comprise a virtual machine (VM) session with surface area that has verisimilitude to the device-driver exposed runtime environment for a given OS. The DSOS may be layered directly above a hypervisor (e.g., a VM monitor) and may use VMCalls to instantiate itself, request resources, etc. DSOSs may be limited to contain sufficient services to affect the behavior of the single, hosted device driver(s). There may be many DSOS instances, each capable of communicating with the full OS instance via platform instrumentation, called the DSOS—proxy. The platform may provide the DSOS and the proxy stub within the full OS. As such, the platform may provide DSOS and the stub of code in the full OS to proxy accesses into the virtual Input/Output manager, or Windows® software, in this example.

Thus, as shown in FIG. 1, each process 108 may comprise a driver container having an operating system OS, user applications APPS, device driver stubs DD, and firmware FW. However, it should be noted that such isolation is not required to implement many of the embodiments disclosed herein.

Thus, a variety of embodiments may be realized. For example, an apparatus 100 may include an integrated circuit package 126 to house the first processor p1 and the second processor P2, among others (e.g., P3). A computer motherboard 130 may be attached to the first processor P1 and the second processor P2, and the computer motherboard 130 may be used to supply operational power to the first processor P1 and the second processor P2, among others. The power may be supplied using a power supply PS.

In some embodiments, the processors P1, P2 may include one or more registers having a status bit T to indicate the thermal trip condition. In some cases, the processors p1, P2, may indicate a thermal trip condition using a logging register or status flag bit L. Thus, the processors P1, P2 or the circuit package 126 may include one or more registers 134 to record a history of events including thermal trip conditions. In some embodiments, the status bits T, L may be included in a single register 134, and in some embodiments the status bits T, L may be included in a number of registers. Thus, the thermal trip condition may be indicated by checking the status of a status flag bit or a log flag bit, as well as the state of associated registers.

Some embodiments may include an absolute or relative indication of processor temperature as part of indicating a thermal trip condition. For example, an absolute indication might include the ability to indicate a specific, numeric operating temperature (e.g., 50 C. or 60 C.). A relative indication might include the ability to communicate that the processor is warmer or cooler than another processor core within the same integrated circuit package, or another component attached to the same motherboard, or even another processor or component located in another platform. This relative indication may comprise a status bit that indicates “warmer” or “cooler”, or some group of bits that indicates 10 C. warmer, or 20 C. cooler, for example. For more information regarding some types of thermal trip indications that may be provided by processor manufacturers, please see the reference “Intel® Pentium® 4 Processor on 90 nm Process, Thermal and Mechanical Design Guidelines, Design Guide,” pgs. 24-28, February 2004.

Thermal trip condition indications may occur in response to a number of circumstances. As noted above, a thermal trip condition indication may occur in response to an over-temperature operating situation, such as an absolute core temperature which exceeds 90 C., or a relative core temperature in one processor which is at least 10 C. greater than the core temperature of another processor. However, thermal trip conditions may be indicated in response to other circumstances, perhaps indirectly, such as when a thermal trip condition is indicated by a throttling condition associated with a processor.

Other embodiments may be realized. For example, a system 110, perhaps comprising a laptop or desktop computer, may include one or more apparatus 100 as described above. The system 110 may also include one or more memories MEM, including a flash memory, to store information INFO generated by processes (e.g., process VMn) that are transported to, and received by, other processors that are less thermally burdened than the processor originally assigned to execute the process.

The system 110 may include a plurality of apparatus 100, such as a group of computers, coupled to a bus 140 or a network 144 (which may comprise a wired or wireless network). Thus, the system 110 may include a computer motherboard 130 attached to the first processor p1, and an expansion board 148 coupled to the computer motherboard 130 and attached to a second processor P4. The bus 140 or network 144 may be used to transport one or more processes 108 (e.g., process VMn) from one processor P1 to another processor P5. For example, a process VMn may be transported from processor p1 to processor P2 in the same package, or from processor P1 across a bus 140 or network 144 to another processor P5. In some embodiments, the system 110 may include an antenna 154 to transmit information INFO generated by various processes 108 to a wireless network 160.

Any of the components previously described can be implemented in a number of ways, including simulation via software. Thus, the apparatus 100; system 110; processes 108, VM0, VM1, . . . , VMn+1; processors 114, p1, P2, . . . , P5, Pn; platform 122; circuit packages 126; motherboard 130; computer 132; registers 134; bus 140; network 144; expansion board 148; antenna 154; wireless network 160; user applications APPS, device driver stubs DD; bits T, L; firmware FW; information INFO; memory MEM; operating systems OS, and power supply PS may all be characterized as “modules” herein.

Such modules may include hardware circuitry, single and/or multi-processor circuits, memory circuits, software program modules and objects, and/or firmware, and combinations thereof, as desired by the architect of the apparatus 100 and systems 110, and as appropriate for particular implementations of various embodiments. For example, such modules may be included in a system operation simulation package, such as a software electrical signal simulation package, a power usage and distribution simulation package, a capacitance-inductance simulation package, a power/heat dissipation simulation package, a signal transmission-reception simulation package, and/or a combination of software and hardware used to operate, or simulate the operation of various potential embodiments.

It should also be understood that the apparatus and systems of various embodiments can be used in applications other than single and multi-core processors attached to motherboards, or coupled via networks, and thus, various embodiments are not to be so limited. The illustrations of apparatus 100 and systems 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single and/or multi-processor modules, single and/or multiple embedded processors, and application-specific modules, including multilayer, multi-chip modules. Such apparatus and systems may further be included as sub-components within a variety of electronic systems, such as televisions, cellular telephones, personal computers, switches, hubs, routers, workstations, radios, video players, vehicles, and others.

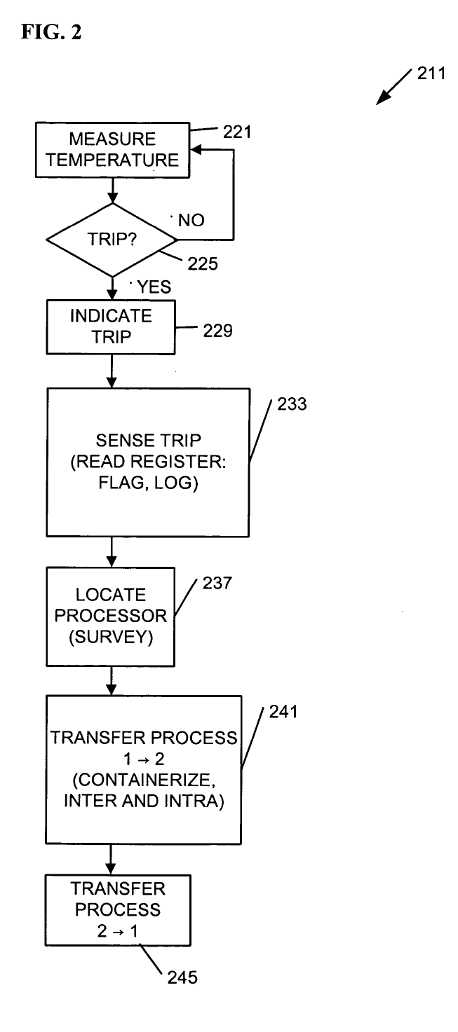

Some embodiments may include a number of methods. For example, FIG. 2 is a flow diagram illustrating several methods 211 according to various embodiments of the invention. For example, a method 211 may include measuring the temperature of one or more processors at block 221. If no thermal trip condition occurs at block 225 (e.g., the measured temperature associated with a particular processor does not exceed some selected limit), then the method 211 may continue with measuring the temperature at block 221.

If a thermal trip condition occurs at block 225, then the method 211 may continue with indicating a thermal trip condition at block 229, perhaps indirectly, by throttling the processor (e.g., using a stop-clock mechanism). The thermal trip condition may also be indicated directly by setting a bit in a register (e.g., the T bit described above), or setting several bits to indicate a relative or absolute operational condition, such as processor core temperature. A combination may also be used, such as explicitly indicating the thermal trip condition in response to a processor throttling condition, or vice-versa (e.g., implementing thermal throttling in response to a thermal trip condition).

One or more flags or status bits in a log register may be set to indicate that the thermal trip condition has occurred some time in the past, since the last system reset, or power-on cycle, for example. Any one or more of the bits or registers described herein may comprise “sticky” bits, which are not reset until the processor is power-cycled, or the sticky bit is specifically reset by a software command.

The method 211 may continue at block 233 with sensing the thermal trip condition indicated by the processor executing a process, using the same processor or another processor, such as a supervisor processor (e.g., referring back to FIG. 1, processor P4 may sense a thermal trip condition which exists with respect to processor p1). The thermal trip condition may be sensed in a number of ways, as described above (e.g., directly, by reading a status register or log register of a processor to sense an associated thermal trip condition, or indirectly, by determining that thermal throttling has occurred in the past, or is presently occurring). Thus, sensing the thermal trip condition may occur by reading a register to determine the condition of a thermal status flag or a thermal status log, or both, associated with the first processor.

In some embodiments, the method 211 may continue at block 237 with locating the second processor to which the process executing on the first processor exhibiting the thermal trip condition is to be transferred. For example, the second processor may be located as a processor that has a thermal loading less than the thermal loading of the currently-executing (first) processor. This may be determined by reading a register in the second processor, or by surveying multiple processors, including the second processor, to determine the relative thermal loading of the second processor with respect to the first processor (as well as the other processors surveyed).

The method 211 may continue with transferring one or more processes from the first processor to the second processor in response to sensing the existence of the thermal trip condition at block 241. Transferring the processes at block 241 may include containerizing one or more of the processes, and then transporting the processes from the first processor to the second processor.

In some embodiments, the processes may be transferred from one processor core to another in the same integrated circuit package, or between processor cores housed in two separate packages, perhaps attached to the same motherboard, or housed within the same computing platform. Process transport may also occur by transferring the process from a first processor in a first computer coupled to a network to a second processor in a second computer coupled to the same network, either wired or wireless.

In response to sensing a thermal trip condition indicated by the second processor, the method may continue at block 245 with transferring the process from the second processor back to the first processor. It should be noted that transfer of processes between processors in either direction (e.g., from the first to the second processor, and vice-versa), may occur inter-platform (e.g., between processor cores in a single circuit package, or between processor packages housed in a single platform), and intra-platform (e.g., between processors coupled to each other via a network or bus).

Various embodiments may be realized. For example, after a platform is initialized, a platform hypervisor, such as a VM monitor (VMM—see FIG. 1), may be launched, which in turn launches a plurality of virtual machines (e.g., VM0, VM1, . . . , VMn+1). If the platform does not support driver encapsulation, then process migration to support thermal management may or may not be performed.

If thermal management is to be effected via process transfer, a status bit or register may be monitored to determine whether a thermal trip condition has occurred in the past, or if such a condition currently exists. Thermal throttling activity may also be examined. In any case, the chosen conditions may be monitored, and normal operations pursued if no thermal trip condition is indicated.

If such a condition is indicated, either directly or indirectly, one or more processes may be transferred from one processor to another. As the processor indicating the thermal trip condition is able to off-load processes via transfer within a platform, or between platforms, its processing efficiency may be improved.

It should be noted that the methods described herein do not have to be executed in the order described, or in any particular order. Moreover, various activities described with respect to the methods identified herein can be executed in repetitive, simultaneous, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java, Smalltalk, or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment, including Hypertext Markup Language (HTML) and Extensible Markup Language (XML). Thus, other embodiments may be realized.

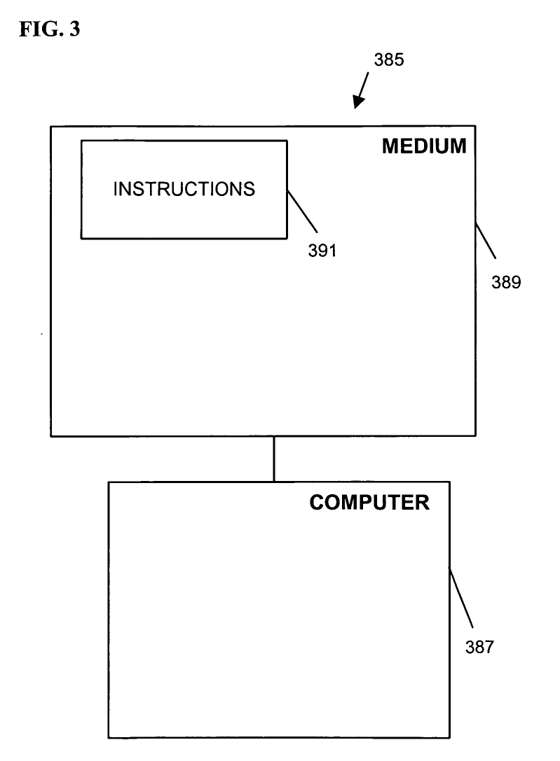

FIG. 3 is a block diagram of an article 385 according to various embodiments, such as a computer, a memory system, a magnetic or optical disk, some other storage device, and/or any type of electronic device or system. The article 385 may include a computer 387 (having one or more processors) coupled to a computer-readable medium 389, such as a memory (e.g., fixed and removable storage media, including tangible memory having electrical, optical, or electromagnetic conductors) or a carrier wave, having associated information 391 (e.g., computer program instructions and/or data), which when executed by the computer 387, causes the computer 387 to perform a method including such actions as sensing a thermal trip condition indicated by a first processor executing a process, and transferring the process from the first processor to a second processor in response to sensing the existence of the thermal trip condition.

Further activities may include reading a register to determine the condition of a thermal status flag or a thermal status log, or both, associated with the first processor. Additional activities may include transferring the process from a first processor located in a first integrated circuit package to the second processor located in a second integrated circuit package, or transferring the process from the first processor located in a first computer coupled to a network to the second processor located in a second computer (also coupled to the network). Other activities may include any of those forming a portion of the methods illustrated in FIG. 2 and described above.

Implementing the apparatus, systems, and methods disclosed herein may improve processing efficiency by avoiding borderline thermal dissipation environments. This is because intelligently migrating processes that place a heavy burden on a given processor to other processors which are less burdened may avoid the specter of thermal throttling.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, including:
a first processor to indicate a thermal trip condition associated with the first processor; and
a second processor to receive a process from the first processor and to execute the process after the thermal trip condition is indicated.

2. The apparatus of claim 1, further including:
an integrated circuit package to house the first processor and the second processor.

3. The apparatus of claim 1, further including:
a computer motherboard attached to the first processor and the second processor.

4. The apparatus of claim 1, wherein the first processor includes:
a register having a status bit to indicate the thermal trip condition.

5. The apparatus of claim 1, wherein the thermal trip condition is indicated by a status of one of a status flag or a log flag.

6. The apparatus of claim 1, wherein the thermal trip condition is indicated by a throttling condition associated with the first processor.

7. The apparatus of claim 1, wherein the thermal trip condition is indicated in response to one of a relative core temperature or an absolute core temperature.

8. The apparatus of claim 1, wherein the first processor is substantially thermally isolated from the second processor.

9. A system, including:
a first processor to indicate a thermal trip condition associated with the first processor;
a second processor to receive a process from the first processor and to execute the process after the thermal trip condition is indicated; and
a flash memory to store information generated by the process.

10. The system of claim 9, further including:
a computer motherboard to supply operational power to the first processor and the second processor.

11. The system of claim 9, further including:
at least one of a bus or a network to transport the process from the first processor to the second processor.

12. The system of claim 9, further including:
a register to record a history of multiple events including the thermal trip condition.

13. The system of claim 9, further including:
a computer motherboard attached to the first processor; and
an expansion board coupled to a computer motherboard and attached to the second processor.

14. The system of claim 9, further including:
an antenna to transmit information generated by the process to a wireless network.

15. A method, including:
sensing a thermal trip condition indicated by a first processor executing a process; and
transferring the process from the first processor to a second processor in response to the sensing.

16. The method of claim 15, further including:
transferring the process from the second processor to the first processor in response to sensing a thermal trip condition indicated by the second processor.

17. The method of claim 15, further including:
reading a register of the first processor to sense the thermal trip condition.

18. The method of claim 15, further including:
locating the second processor as a processor having a thermal loading less than a thermal loading of the first processor.

19. The method of claim 15, further including:
indicating the thermal trip indication in response to a processor throttling condition.

20. The method of claim 15, further including:
containerizing the process; and
transporting the process from the first processor to the second processor.

21. The method of claim 15, further including:
surveying multiple processors, including the second processor, to determine a relative thermal loading of the second processor with respect to the first processor.

22. A computer-readable medium having instructions stored thereon which, when executed by a computer, cause the computer to perform a method comprising:
sensing a thermal trip condition indicated by a first processor executing a process; and
transferring the process from the first processor to a second processor in response to the sensing.

23. The computer-readable medium of claim 22, wherein the instructions, when executed by the computer, cause the computer to perform a method comprising:
transferring the process from the first processor located in a first computer coupled to a network to the second processor located in a second computer coupled to the network.

24. The computer-readable medium of claim 22, wherein the instructions, when executed by the computer, cause the computer to perform a method comprising:
reading a register to determine the condition of one of a thermal status flag or a thermal status log associated with the first processor.

25. The computer-readable medium of claim 22, wherein the instructions, when executed by the computer, cause the computer to perform a method comprising:
transferring the process from the first processor located in a first integrated circuit package to the second processor located in a second integrated circuit package.
